(19) United States
(12) Patent Application Publication
(10) Pub. No.: US 2013/0346599 A1
(43) Pub. Date: Dec. 26, 2013

(54) Systems and Methods for Monitoring Media Interactions

(71) Applicants: Samuel Kell Wilson, Sydney (AU); John Forrester, Sydney (AU); Tim Smith, Tokyo (JP)

(72) Inventors: Samuel Kell Wilson, Sydney (AU); John Forrester, Sydney (AU); Tim Smith, Tokyo (JP)

(21) Appl. No.: 13/855,024

(22) Filed: Apr. 2, 2013

Related U.S. Application Data
(60) Provisional application No. 61/663,537, filed on Jun. 23, 2012.

(30) Foreign Application Priority Data
Jun. 23, 2012 (AU) AU2012901353

(51) Int. Cl. H04L 12/26

(52) U.S. Cl. CPC H04L 43/04
USPC 709/224

(57) ABSTRACT

The embodiments disclosed herein are focussed on media interactions at mobile devices, such as tablet PCs, cellular telephones, and other handheld devices (for example iOS, Windows Mobile and Android devices). Some embodiments relate to an arrangement whereby a media item (such as video data) is streamed for playback at the mobile device. A software application executing at the mobile device monitors user interactions with the device during that media item playback (using any one or more of the available device inputs, which may include the likes of touchscreens, cameras, buttons, microphones, gyroscopes, and so on). The timing and nature of these user interactions is analysed relative to media event data defined, thereby to identify correlations. The presence/absence of such correlations may be used for a number of purposes, such as media lockout control, competitions/promotions, entertainment provision, data collection/analysis, and similar.

### FIELD OF THE INVENTION

The present invention relates to systems and methods for monitoring media interactions. Embodiments of the invention have been particularly developed for providing additional functionalities to mobile devices in the context of media playback. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

In the context the Internet, there is a significant degree of benefit in identifying approaches for encouraging users to view particular content. This is particularly relevant for web-delivered marketing material. Common approaches include the provision banner ads and the like alongside or superimposed on media content, so as to place such marketing material in the gaze of a user who wishes to view the media content. However, such approaches continue to decrease in effectiveness as users become increasingly desensitised to such marketing material, and tend to at times become somewhat oblivious to its presence.

### SUMMARY OF THE INVENTION

It is an object of the present invention to overcome or ameliorate at least one of the disadvantages of the prior art, or to provide a useful alternative.

One embodiment provides a method, performed at a server device, for monitoring media interactions at a client device, the method including:

receiving, from the client device, interaction data indicative of a plurality of interactions, wherein each interaction is associated with an interaction measure and an interaction time, wherein the interactions are made during playback of a media data stream at the client device;

processing the interaction data relative to media event data for the media data stream, wherein the media event data is indicative of a plurality of media events having respective event times defined relative to the media data stream; and

identifying one or more correlations between the interactions and media events.

One embodiment provides a method, performed at a client device, for enabling monitoring of media interactions at a the client device, the method including:

providing, at the client device, a rendering of a media stream;

operating an interaction monitoring module for monitoring one or more predetermined input devices of the client device during rendering of the media stream;

in response to the monitoring module, defining data indicative of a plurality of interactions, wherein each interaction is associated with an interaction measure and an interaction time;

sending data indicative of the interactions to a server device.

One embodiment provides a method, performed at a client device, for enabling monitoring of media interactions at a the client device, the method including:

providing, at the client device, a rendering of a media stream;

downloading, from a server, media event data for the media data stream, wherein the media event data is indicative of a plurality of media events having respective event times defined relative to the media data stream; and

operating an interaction monitoring module for monitoring one or more predetermined input devices of the client device during rendering of the media stream;

in response to the monitoring module, defining data indicative of a plurality of interactions, wherein each interaction is associated with an interaction measure and an interaction time;

processing the interaction data relative to media event data for the media data stream; and

identifying one or more correlations between the interactions and media events.

One embodiment provides a method, performed at a server device, for monitoring media interactions at a client device, the method including:

receiving, from the client device, data indicative of a requested media item; and

downloading, to the client device, media event data for the media data stream, wherein the media event data is indicative of a plurality of media events having respective event times defined relative to the media data stream;

wherein the client is configured to process interaction data indicative of a plurality of interactions at the client device, wherein each interaction is associated with an interaction measure and an interaction time, wherein the interactions are made during playback of a media data stream at the client device;

such that the client is enabled to identify one or more correlations between interactions and media events.

One embodiment provides a computer program product for performing a method as described herein.

One embodiment provides a non-transitive carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1 schematically illustrates a framework according to one embodiment, including a mobile device, media server, and monitoring server.

FIG. 2A illustrates a method according to one embodiment.

FIG. 2B illustrates a method according to one embodiment.

FIG. 2C illustrates a method according to one embodiment.

FIG. 3 illustrates an IT framework that may be leveraged for the implementation of various embodiments.

### DETAILED DESCRIPTION

Described herein are systems and methods for monitoring media interactions, and the embodiments disclosed herein are focussed on media interactions at client devices. The present specification focuses primarily on mobile client devices, such as tablet PCs, cellular telephones, and other handheld devices (for example iOS, Windows Mobile and Android devices). However, it should be appreciated that the technology is by no means necessarily limited to particular hardware devices. In overview, some embodiments relate to an arrangement whereby a media item (such as video data) is streamed for playback at the mobile device. A software application executing at the mobile device is configured to monitor user interactions with the device during that media item playback (using any one or more of the available device inputs, which may include the likes of touchscreens, cameras, buttons, microphones, gyroscopes, and so on). The timing and nature of these user interactions is analysed relative to media event data defined, thereby to identify correlations. The presence/absence of such correlations may be used for a number of purposes, such as media lockout control, competitions/promotions, entertainment provision, data collection/analysis, and the like. One very specific example of implementation of such technology is to instruct a user to, whilst viewing a football match, touch the location of a particular sponsor's logo (printed on a real-world substrate) each time it appears on screen.

As used herein, the terms “media stream”, “streamed” and “streaming” should be read broadly enough to encompass where media is played at a local device from data in local storage, or played back at a local device from a buffer of temporary data received from a remote server.

### Device/Server Framework

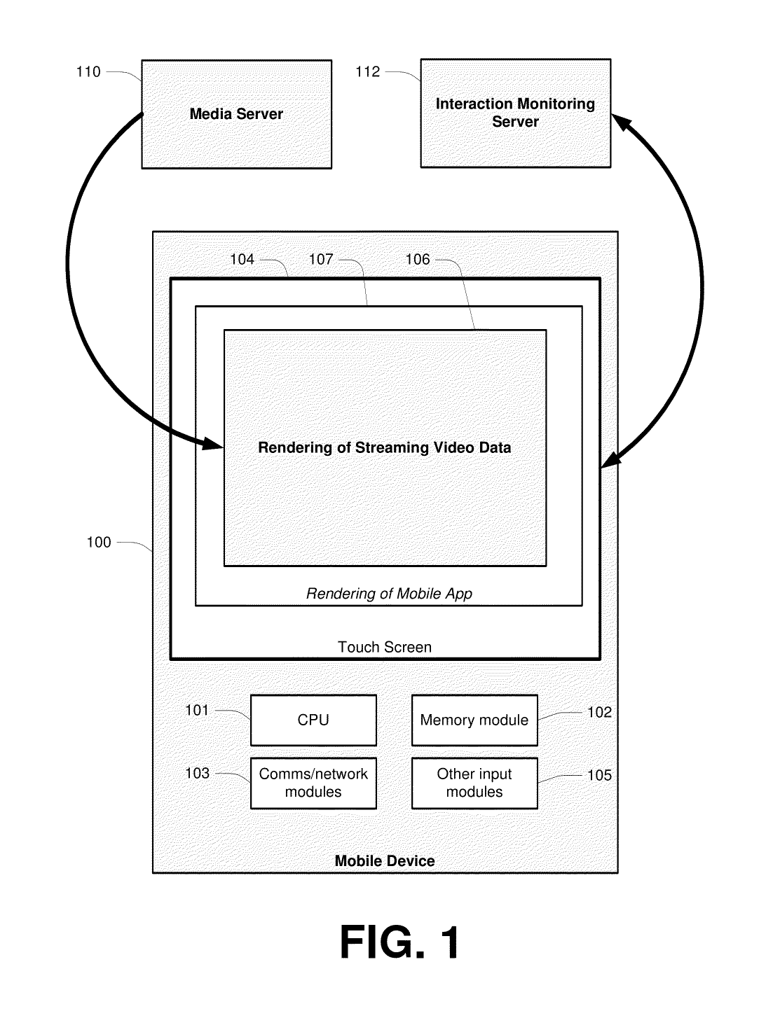

FIG. 1 illustrates a framework that allows for the monitoring of media interactions according to embodiments discussed herein. A mobile device 100 (such as an iPhone, iPad, Android device, or other mobile device) includes a CPU 101 coupled to a memory module 102. Memory module 102 conceptually represents both volatile and non-volatile memory for the sake of simplicity. Communications/network modules 103 (which may include a plurality of individual hardware modules such as cellular telecommunications components, WiFi components, and so on) enable mobile device 100 to communicate with other devices. Device 100 includes a touch screen 104 and other input modules 105 (optionally including one or more of a camera, physical button, motion sensing component such as a gyroscope, microphone, light sensor, or the like), these allowing a user to interact with the device.

CPU 101 and memory module 102 allow device 100 to execute a mobile app 107 (with an on-screen rendering of app 107 being illustrated in FIG. 1). App 107 is provided by way of executing computer readable code stored on a carrier medium such as module 102 via CPU 101. In the present embodiment, mobile app 107 has two main functionalities: firstly allowing the provision of an object for the rendering of media data (a “media stream”); and secondly a functionality whereby user interactions are monitored during playback of the media data. In the context of FIG. 1, the media data is video data rendered in a video display object 106 provided by app 107 and viewable on touch screen 104. In some embodiments the video display object is provided by other than app 107, with app 107 executing concurrently thereby to allow monitoring of interactions during playback of video data via the otherwise provided video object.

Execution of app 107 configures device 100 to perform a method for enabling monitoring of media interactions at a mobile client device, as discussed below. The expression “media interactions” is used to describe interactions a user of a handheld device makes with that device during the playback of a media item (such as rendering of live-streamed video).

The method performed by way of app 107 includes, during a rendering of a media stream, operating an interaction monitoring module for monitoring one or more predetermined input devices of the mobile client device during rendering of the media stream. These interactions may be initiated via an input device in the form of touchscreen 104 and/or one or more of input modules 105. That is, monitoring of interactions may be limited to a single input device, or cover multiple input devices. The method additionally includes, in response to the monitoring module, defining data indicative of a plurality of interactions, wherein each interaction is associated with an interaction measure and an interaction time. The interaction measure quantifies the interaction. For example:
In the context of a touch screen interaction, the interaction measure may describe that a touch has occurred, the position at which the screen is touched, a path/trajectory of moving touch, a multi-touch gesture, or the like.
In the context of buttons, the interaction measure may describe that a particular button has been pressed, a duration of button press, sequence of button presses, rhythm of button presses or the like.
In the context of a motion sensor, such as a gyroscope, the interaction measure may describe that a device has been moved, or moved in a particular way, ranging from a simple “shake” to a more precisely defined orientation or trajectory.
In the context of a microphone, the interaction measure may describe characteristics of an observed sound, thereby to (by way of example) identify words and/or tunes.
In the context of a camera, the interaction measure may leverage motion tracking (for example eye tracking) technologies.

Other input devices may also be used, including but not limited to ultrasonic input devices, game controllers, devices responsive to other human sensory characteristics, temperature sensors, and so on. It will be appreciated that the scope of the technology disclosed herein should in no way be limited by reference to those input devices that are known or common in the marketplace as of the patent application priority date.

It will be appreciated that the precise manner by which an interaction measure is defined varies greatly between embodiments, and between input devices, thereby providing a great deal of design freedom and creativity when configuring specific implementations.

The method performed based on app 107 then includes sending data indicative of the interactions to a server device. The server device then, in some embodiments, provides return instructions that effect downstream operation of device 100. Additional discussion of the manner in which the server uses data indicative of monitored interactions is provided further below.

App 107 is preferably configured to provide the server device data indicative of the media stream being viewed, and to define the interaction times relative to a known event time for the media stream, such as a playback origin or playback marker. This enables the server to reconcile each interaction with media event data defined for the media stream being viewed at device 100. The sent data enables the server device to process the interaction data relative to media event data for the media data stream, as discussed in more detail further below. In in overview, the media event data is indicative of a plurality of media events having respective event times defined relative to the media data stream. The server is configured to identify one or more correlations between the interactions and media events.

A media server 110 is, in the present embodiment, responsible for delivering streamed media to device 100. It will be appreciated that there may be multiple media servers in practice. Mobile app 107 is configured for communicating with the media server, thereby to negotiate the delivery of streamed media data. For example, app 107 uses a URL indicative of a desired media item thereby to request streaming of that media item from server 110.

An interaction monitoring server 112 receives the data indicative of media interactions. In some embodiments monitoring server is additionally responsible for instructing media server 110 to deliver specific media items to a specified device 100. In some cases server 112 includes (or otherwise provides corresponding functionality to) a media server 110.

Interaction monitoring server 112 is configured to receive data indicative of interactions from app 107 executing on device 100. Moreover, interaction monitoring server 112 receives such data from a plurality of devices such as device 100, and is able to associate each set of interaction data with a particular device (for example by way of a user account) and preferably with a media item that is being viewed at that device. For example, when a user launches app 107, identification data is communicated to the server, and the server is additionally provided with data indicative of a media item that is being viewed (preferably including data indicative of the playback status relative to a known timing origin).

Delving further into the detail, server 112 executes software instructions thereby to perform a method including receiving, from the mobile client device, interaction data indicative of a plurality of interactions, wherein each interaction is associated with an interaction measure and an interaction time. These are for interactions are made during playback of a media data stream at the client mobile device. The method additionally includes processing the interaction data relative to media event data for the media data stream, wherein the media event data is indicative of a plurality of media events having respective event times defined relative to the media data stream. The method then includes identifying one or more correlations between the interactions and media events, as discussed further below.

### Exemplary Device Method

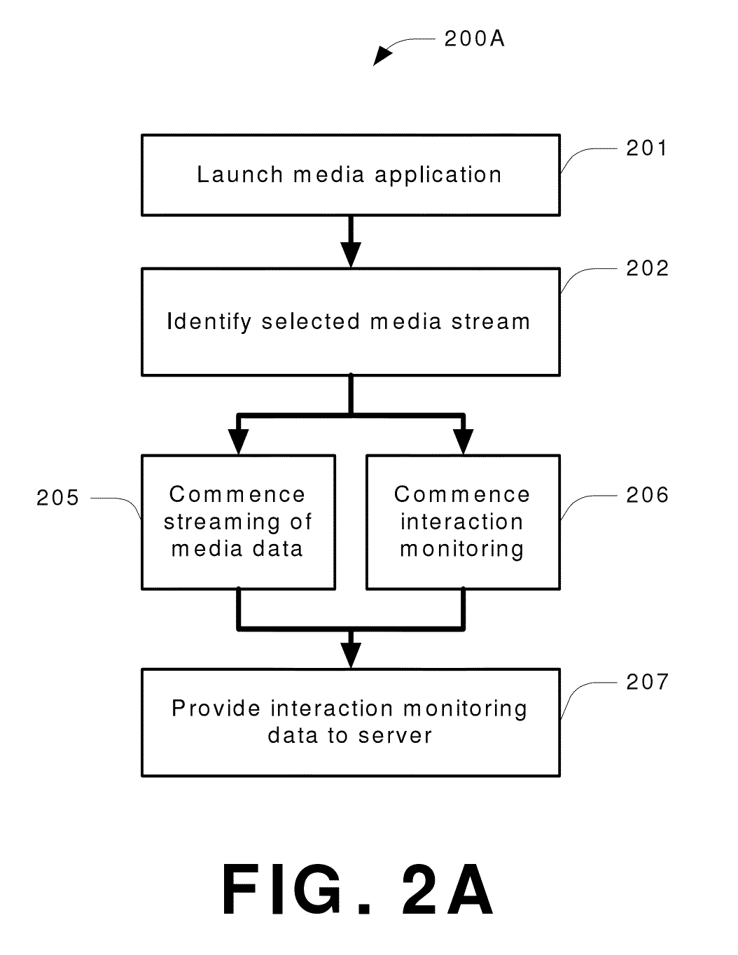

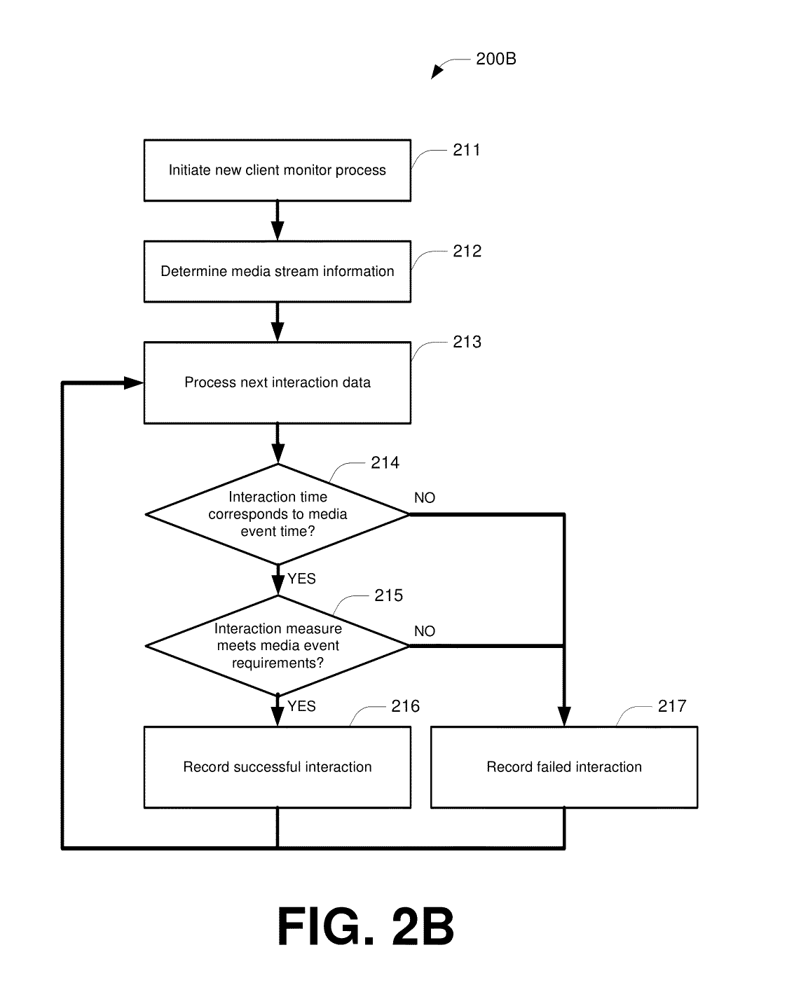

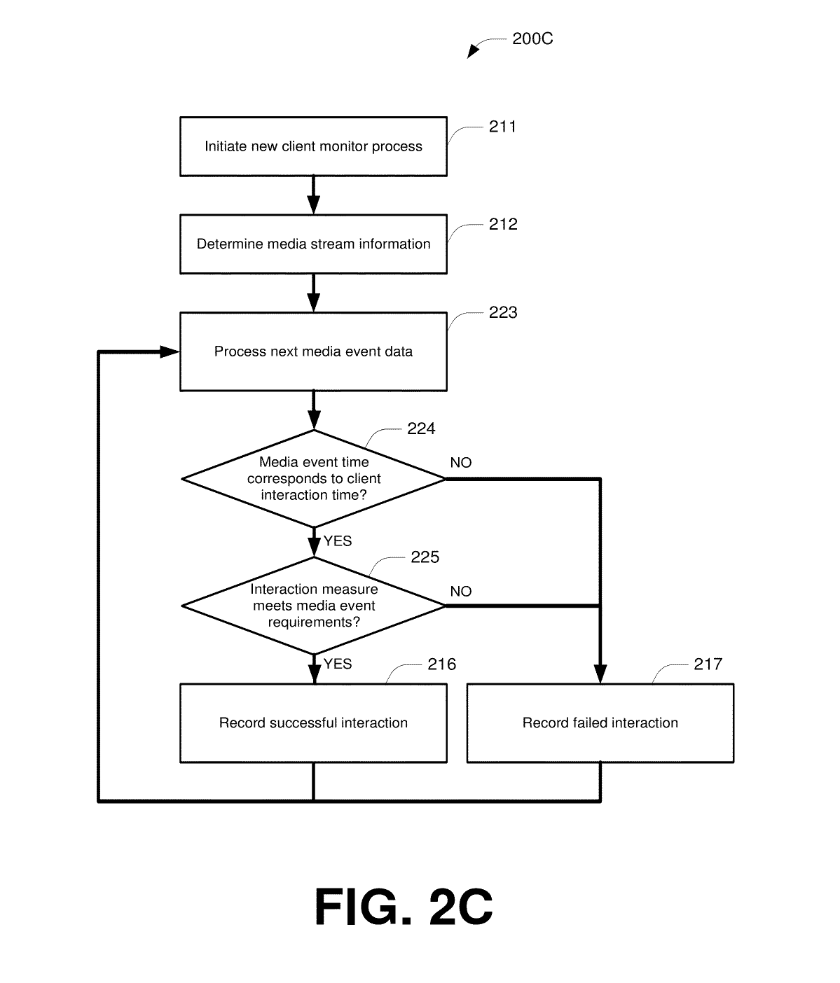

FIG. 2A illustrates an exemplary method 200A performed by device 100 on the basis of software instructions that define app 107. Functional block 102 represents a process including launching app 107. This additionally include contacting server 112 thereby to provide identification information (e.g. perform a “log on”).

Following launch, the user is provided with an interface for selecting a media item to view. This may include providing a search engine functionality or the like. Once the user has selected a media item, functional block 202 represents a process whereby app 107 identifies a location from which the required media stream is available, being server 110 in the current example. Streaming/rendering of the media stream commences at 205. Concurrently, at 206, app 107 commences interaction monitoring. Specifically, app 107 is configured to monitor data being generated by one or more of the input devices of device 100, as foreshadowed above.

Functional block 207 represents a process whereby data is defined on the basis of the monitoring, and that data provided to server 112. The data may be communicated on an interaction0by-interaction basis, or sent in batches.

### Exemplary Server Methods

FIG. 2B and FIG. 2C illustrate exemplary methods performed by server 112. The first of these illustrates a client monitor process 200B driven by interaction data, whereas the second illustrates a client monitor process 200C driven by media event data. It will be appreciated that further embodiments include hybrid approaches. Additionally, it will be appreciated that in some embodiments device 100 is configured to perform one or more steps of these methods.

Method 200B and method 200C both include, as represented by functional block 211, initiating a new client monitor process. This process is defined for a particular client (i.e. user identified on the basis of a mobile device that has provided identification information when launching app 107), and in some cased for a particular media stream viewing session. Media stream information for the media stream that is to be viewed at the mobile device is determined at 212. This allows for identification of a set of media event data for that media stream.

In the context of method 200B, functional block 213 represents a process including processing a next set of interaction data (i.e. a next combination of an interaction time and interaction measure).

At 214 it is determined whether the interaction time corresponds to a media event time. For example, based on a determined relationship between the time point in the media stream being viewed by the client and the interaction time, it is determined whether the media event data defines a media event at a “corresponding time”. The corresponding time is typically defined as a range or as a point with error allowances, for example to allow a few seconds leeway. In the event that the interaction time does not correspond to a media event time, the method progresses to 217, and a failed interaction is recorded. In the event that the interaction time does indeed correspond to a media event time, the method progresses to 215.

Functional block 215 represents a determination of correlation between the interaction measure for the interaction under consideration, and requirements defined for the media event with which the interaction time corresponds. Specifically, each media event includes defined requirements, which are able to be compared to the interaction measure. These may include a required value or range of values (optionally with error allowances). In the event that the interaction measure does not meet the media event requirements, the method progresses to 217, and a failed interaction is recorded. In the event that the interaction measure does indeed meet the media event requirements, the method progresses to 216 and a successful interaction is recorded. Following 202 or 206, the method loops to 203 for the next interaction data. This loop continues until further interaction data is no longer available, or the method is otherwise terminated.

Turning to method 200C, functional block 223 represents a process whereby next media event data is processed. In this case, the server begins by identifying a next media event in the media event stream, and determines whether there is an interaction that corresponds in time and measure to requirements of that event (hence being event driven). Time correspondence is assessed at 224, and measure/requirements analysis performed at 225, with the method either progressing to recording of a successful interaction at 216 or a failed interaction at 217, before looping to 206 (similar to method 200B).

Methods 200B and 200C may be performed substantially in real-time (i.e. during media streaming), in which cases follow-on effects of successful/failed interactions may impact on the streaming (for example by providing feedback to the user, initiating a media lockout, or the like). In some cases, due to network latency, method 200A or 200B is performed by device 100 in such circumstances, with the server communicating the media event information to the device thereby to allow for device-side analysis of correspondences.

In some embodiments methods 200B and 200C are performed at a time independent of the media streaming. This is sufficient in instances where the outcome of having successful or failed interactions affects future events, for example the determination of competition winners or analysis of marketing effectiveness.

### Identifying Correlations

It will be appreciated that the manner by which correlations are identified varies significantly between implementations, depending on the nature of input devices monitored, nature of interaction measure recorded, and purpose of implementation. A number of examples are provided in the table below:

| Input device | Interaction Measure | Media Event Requirement |
|---|---|---|
| Touch screen | Presence of touch | Presence of touch |
| Touch screen | Touch position | Concordance with predefined |
| | (defined by | touch position (defined by |
| | coordinate) | coordinate or coordinate |
| | | range) |
| Touch screen | Touch position | Concordance with predefined |
| | and trajectory | range of acceptable touch |
| | | points and trajectories |
| Touch screen | Degree of touch | Greater than threshold degree |
| | movement | of touch movement (for example |
| | | to indicate a user rapidly |
| | | rubbing the screen) |
| Microphone | Audio signal | Greater than threshold audio |
| | intensity | signal intensity (in essence |
| | | to identify presence of user- |
| | | initiated intentional sound) |
| Microphone | Audio waveform | Concordance with predefined |
| | | word or tune (defined by stored |
| | | audio waveform) |
| Buttons | Button press | Greater than threshold button |
| | duration | press duration |
| Buttons | Button press | Concordance with predefined |
| | sequence | button press sequence |
| Motion sensor/ | Movement data | Concordance with predefined |
| gyroscope | | movement data type/range |

In some cases requirements are defined in terms of acceptable measurement values and allowable error ranges, and in other cases by ranges or measurement values and/or thresholds.

In some embodiments identifying a correlation between a given one of the interactions and a media event includes determining a relationship between a client timeline with respect to which the interaction time is defined and a media timeline with respect to which the event times are defined; and determining whether the interaction time corresponds to one of the event times.

Specific examples of instructions for interactions are outlined below thereby to provide an indication of the breadth of application of the present technology.
Instructing users to yell each time a goal is scored in a game of football.
Instructing users to perform an interaction (such as a touch) each time a predetermined business' marketing information appears on-screen (either via a real-world object displaying marketing material, or an electronically generated overlay). This may include brand names and/or logos.
Instructing users to trace an object in a video, or use their finger to follow the path of an object in that video.
Instructing users to shake their device at the times of real-world events shown in the video.
Instructing users to sing along with music provided via the video.

It will be appreciated that there are many other possible approaches.

### Downstream Utilisation of Monitoring Outcomes

Specific examples of implementations of the downstream utilisation of monitoring outcomes are discussed below. It should be appreciated that these are intended to provide guidance as to the breadth of possibilities, and should not be regarded as necessarily limiting.

### Example 1

### Media Lockouts

In some cases failure of a user to satisfy a threshold level of successful interactions results in a media lockout. That is, for a user to continue to view a media stream, it is necessary that the user make a threshold number of successful interactions. In one example, the user is instructed to click a particular object each time it appears on-screen (with this object either being present in the media stream of overlaid on the media stream by app 107). Failure to click the object with sufficient regularity results in a media lock-out. This can be used to ascertain viewer awareness, increase brand recognition (for example by using a branded object), obtain market research information, and so on. This can be relevant where an advertiser uses the current technology to deliver marketing material, and paying attention to that marketing material (as evidenced by interaction) is necessary to continue to watch a media stream (such as a free-streamed live sporting event). Marketing revenues may be used to support free streaming of streaming of, for example, a live sporting event.

### Example 2

### Competitions

Users may be provided with instructions to perform specified interactions, and users with the greatest number of successful interactions rewarded with prizes. It will be readily appreciated how this can be tied to an advertising campaign.

### Example 3

### Viewer Analytics

Data collected using the current technology may be used to assess how observant users are of certain events displayed on-screen, for example to assess the effectiveness of advertising or the like.

### Example 4

### Marketing Promotions

In some cases, interaction monitoring is used on the context of a marketing promotion, thereby to increase brand awareness. This may be in the form of using a brand-related interaction, or more generally by overall branding of the promotion or of app 107.

### Specific Application to Pre-Roll Advertisements

It is common for web publishers to make use of “pre-roll” advertisements when delivering media content. A per-roll advertisement is a media item, usually video, that is played prior to the commencement of a requested media item. Conventionally, it is common for such pre-roll advertisements to be unavoidable, for example by preventing a user from skipping, scrubbing, or otherwise bringing forward completion of viewing. In some cases such prevention continues only for a predetermined time or portion of the advertisement (for example the first five seconds, before providing the viewer with an option to skip the advertisement).

The technology described is readily adapted to provide useful functionality in the context of pre-roll advertisements. In particular, a user is directed to perform a predefined interaction during playback of the pre-roll advertisement and, in the case that the interaction is successfully completed, the remainder of the advertisement is skipped (allowing the user to view the initially requested media content item).

One example of a predetermined interaction is for the user to identify the subject matter being advertised (for example in terms of a company, product, or a marketing slogan). The identification might be by any one of the interaction types discussed above, although voice interaction is seen as preferable in some respects. For instance, a viewer begins watching a pre-roll video for “Company X”, and in response to saying the words “Company X” is permitted to skip the remainder of the advertisement.

It will be appreciated that the advertising is, in effect, skipped once it has already proven to have conveyed brand/product awareness. Analytic information regarding the time it takes for users to complete the interaction may be useful to advertisers; it enables analysis of how quickly advertising is associated with brands/products. This might occur both in terms of time into an advertisement and in terms of time for which a particular campaign has been in circulation. For example, one would expect a slower interaction delay for a new campaign, and for the interaction delay to decrease as the age of the campaign increases. Behaviour outside of that norm might have particular relevance (for example showing users enjoy watching a particular advertisement, in preference to skipping it).

### Video Game Applications

In some embodiments the technology disclosed herein is applied to a video game environment, as discussed below.

One category of video game embodiments treat a video game as a form of input device, and overlay media content on a video game display. For example, a transparent video overlay is applied to a video game, that video overlay having associated media event data. Activity within the video game data is monitored thereby to define interaction data, and that interaction data is compared with the media event data, for example in the manner outlined above.

So as to provide a simple practical example, consider a first person shooter game wherein a player shoots an in-game weapon at in-game targets defined in a virtual environment. A media item is played back in transparent overlay. This media item displays an advertising logo. The corresponding media event data defines the location of that logo relative to the virtual environment. Video game data is monitored, thereby to determine, for instance, player shot trajectories in the virtual environment. Player shot trajectories are compared to the media event data (i.e. the location of that logo relative to the virtual environment) thereby to determine whether the player has in effect “shot” the logo. It will be recognised that this is achieved as an add-on to a video game without a need to in any way modify the video game data itself.

Another category of embodiments include modification of video game data thereby to enable implantation of additional objects with which a user is instructed to interact, with such interactions being monitored by a remote server.

### Exemplary System-Level Overview

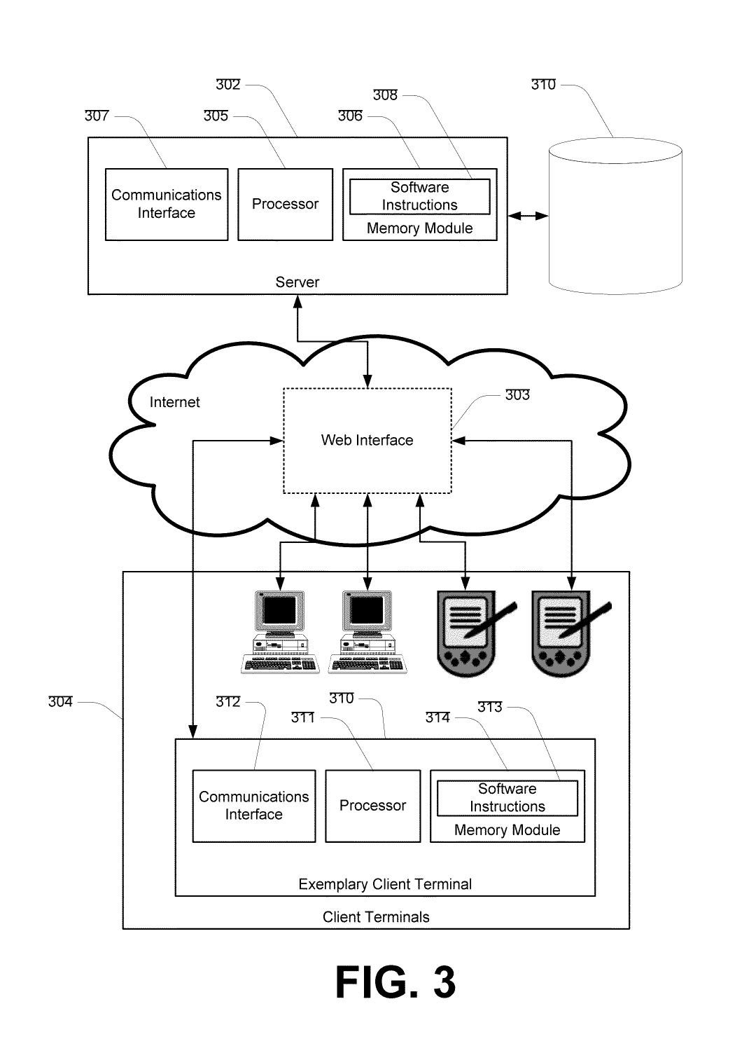

In some embodiments, methods and functionalities considered herein are implemented by way of a server, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

### Conclusions and Interpretation

It will be appreciated that the disclosure above provides various significant systems and methods for delivering streamed media, and for monitoring media interactions.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A method, performed at a server device, for monitoring media interactions at a client device, the method including:
receiving, from the client device, interaction data indicative of a plurality of interactions, wherein each interaction is associated with an interaction measure and an interaction time, wherein the interactions are made during playback of a media data stream at the client device;
processing the interaction data relative to media event data for the media data stream, wherein the media event data is indicative of a plurality of media events having respective event times defined relative to the media data stream; and
identifying one or more correlations between the interactions and media events.

2. A method according to claim 1 wherein identifying a correlation between a given one of the interactions and a media event includes:
determining a relationship between a client timeline with respect to which the interaction time is defined and a media timeline with respect to which the event times are defined; and
determining whether the interaction time corresponds to one of the event times.

3. A method according to claim 2 wherein the interaction time corresponds to one of the event times in the event that the times fall within a predefined time match allowance range.

4. A method according to claim 2 wherein identifying a correlation between a given one of the interactions and a media event additionally includes:
in the case that the interaction time corresponds to one of the event times, determining interaction requirements for the media event having that event time; and
determining whether the interaction requirements corresponds to the interaction measure.

5. A method according to claim 1 wherein the interaction is defined by a touch screen interaction.

6. A method according to claim 5 wherein the interaction measure is defined by a touch position and/or touch trajectory.

7. A method according to claim 1 wherein the interaction is defined by a device movement.

8. A method according to claim 7 wherein the interaction measure is defined by data from a device motion sensor.

9. A method according to claim 1 wherein the interaction is defined by a sound.

10. A method according to claim 9 wherein the interaction measure is defined by one or more characteristics of the sound.

11. A method, performed at a client device, for enabling monitoring of media interactions at a the client device, the method including:
providing, at the client device, a rendering of a media stream;
operating an interaction monitoring module for monitoring one or more predetermined input devices of the client device during rendering of the media stream;
in response to the monitoring module, defining data indicative of a plurality of interactions, wherein each interaction is associated with an interaction measure and an interaction time;
sending data indicative of the interactions to a server device.

12. A method according to claim 11 wherein the sent data enables the server device to process the interaction data relative to media event data for the media data stream, wherein the media event data is indicative of a plurality of media events having respective event times defined relative to the media data stream; and identify one or more correlations between the interactions and media events.

13. A method according to claim 11 wherein the client device defines the interaction times relative to a known event time for the media stream.

14. A method according to claim 11 including a step of communicating to the server device data indicative of the media stream being viewed.

15. A method according to claim 11 wherein the interaction is defined by a touch screen interaction.

16. A method according to claim 15 wherein the interaction measure is defined by a touch position and/or touch trajectory.

17. A method according to claim 11 wherein the interaction is defined by a device movement.

18. A method according to claim 17 wherein the interaction measure is defined by data from a device motion sensor.

19. A method according to claim 11 wherein the interaction is defined by a sound.

20. A method, performed at a server device, for monitoring media interactions at a client device, the method including:
receiving, from the client device, data indicative of a requested media item; and
downloading, to the client device, media event data for the media data stream, wherein the media event data is indicative of a plurality of media events having respective event times defined relative to the media data stream;
wherein the client is configured to process interaction data indicative of a plurality of interactions at the client device, wherein each interaction is associated with an interaction measure and an interaction time, wherein the interactions are made during playback of a media data stream at the client device;
such that the client is enabled to identify one or more correlations between interactions and media events.
